(19) United States
(12) Patent Application Publication
(10) Pub. No.: US 2014/0121890 A1
(43) Pub. Date: May 1, 2014

(54) Apparatuses, Systems, Software and Methods for Wireless Interaction with Vehicle Control Systems

(71) Applicant: Anil GERCEKCI, Bellevue (CH)

(72) Inventor: Anil GERCEKCI, Bellevue (CH)

(21) Appl. No.: 12/100,129

(22) Filed: Apr. 9, 2008

Related U.S. Application Data
(60) Provisional application No. 60/910,867, filed on Apr. 10, 2007.

(51) Int. Cl. B60W 50/08; G05B 19/02; H04B 1/38; G06F 15/16; G06F 3/048; H04K 1/00; H04L 12/22

(52) U.S. Cl. 701/33.2; 455/557; 701/36; 701/1; 709/227; 715/764; 380/270

(57) ABSTRACT

Methods, software, devices, and systems, for wireless interaction with control systems (e.g., control systems integrated with motor vehicles, commercial and/or residential buildings, appliances, or other complex integrated systems). The methods generally include establishing a first wireless communication channel between a handheld communication device and the control system and establishing a service provider communication channel between the handheld device and a service provider. The service provider communication channel generally includes a second wireless communication channel between the handheld communication device and a wireless communication provider node.

### RELATED APPLICATIONS

This application claims the benefit of U.S. Provisional Application No. 60/910,867 (Attorney Docket No. MP1835PR), filed Apr. 10, 2007, the contents of which are incorporated herein by reference in its entirety.

### FIELD OF THE INVENTION

The present invention generally relates to the field of wireless remote control of vehicle and other control system electronics. More specifically, embodiments of the present invention pertain to apparatuses, systems, software, and methods for wireless interaction with vehicle and other control system electronics over a wireless local area network (WLAN).

### BACKGROUND

Remote keyless entry devices for automotive applications have been based essentially on FM transceivers using on-off transmission (OOK) modulation between the key and the vehicle for transferring digital information securely in order to control door opening, honking, etc. Important features of such systems include low power, robustness against hacking (e.g., high communication security) and low cost. Recently some manufacturers have introduced two way systems including a key fob with a screen to display vehicle status information such as internal temperature, tire pressure, door and window open/close status etc. Such equipment may be relatively heavy and/or bulky due to larger batteries, antennas, and processors, in addition to display screens, additional buttons, etc.

It is also desirable to provide sophisticated remote controls for building control systems (e.g., integrated and or independent systems for security, communication, entertainment, air conditioning and/or climate control, lighting, energy, etc.), appliances (e.g., refrigerators, dishwashers, clothes washing machines and dryers, etc), and other durable devices that are increasingly becoming computerized and sophisticated. Adding together the variety of remote controls that it is already necessary and/or desirable for a person to carry (e.g., garage door openers, vehicle remote keys. etc.) with future applications, it is apparent that users may become overwhelmed by the number and diversity of disparate instruments and keys that are needed to carry around to achieve similar control, status, and command functions.

The electronic control systems and other components of durable goods like vehicles, building systems, and appliances are generally designed to operate in the same conditions as the overall system, and to have a life expectancy commensurate with that of the overall system. Thus, electronics that are integrated into a vehicle generally must last eight or more years and operate in relatively extreme temperature, humidity, and vibration environments. Similar constraints may be present in appliances, while the life expectancy of some building systems may be measured in decades. Thus, the components for electronic control systems in these environments may be much more expensive. As a result, some components that may be desirable but which are not essential, such as sophisticated user interfaces including LCD screens and/or other visual displays, keyboards and/or touch-screen inputs, etc., may be omitted from some devices (particularly from lower-end and/or more economical models).

In contrast, handheld communication devices such as cell and/or mobile telephone handsets are typically replaced after one to three years of use and have become widespread. Such devices increasingly include sophisticated user interfaces with color displays with multiple user input methods. The devices also have relatively large antennas and batteries, and the batteries are frequently recharged). Handheld communication devices increasingly include means for short-range wireless communication, such as Wi-Fi wireless LAN (WLAN), Bluetooth, and other wireless communication standards and protocols. Vehicles and other electronic control systems also increasingly include such wireless communication protocols.

Thus, it is desirable to provide sophisticated user interaction with the control systems of vehicles and other durable devices and systems using relatively inexpensive handheld communication devices over a wireless communication channel.

Devices such as cellular and mobile telephone handsets inherently have access to wide- or municipal-area networks (WANs or MANs) for voice communication. They also generally have at least minimal data connectivity to such networks (e.g., via short message service [SMS] messaging), and increasingly have access to high speed (e.g., “broadband”) wide area data networks such as General Packet Radio Service (GPRS), Enhanced Data rates for GSM Evolution (EDGE), Evolution-Data Optimized (EV-DO), etc. Thus, these handheld communication devices may communicate with service providers over these wireless data networks, either directly (e.g., where the service provider is a node in the wireless data network itself) or through a connection over the wireless data network to the internet or to another data network.

### SUMMARY

Embodiments of the present disclosure relate to methods, software, devices, and systems for wireless interaction with control systems (e.g., control systems integrated with motor vehicles, commercial and/or residential buildings, appliances, or other complex integrated systems). The methods generally include establishing a first wireless communication channel between a handheld communication device and the control system and establishing a service provider communication channel between the handheld device and a service provider. The service provider communication channel generally includes a second wireless communication channel between the handheld communication device and a wireless communication provider node.

In some embodiments, the method further includes transferring control system data (e.g., status, maintenance, or other information relevant to the control systems function) from the control system to the handheld device over the first wireless communication channel and transferring that control system data (or a derivative thereof) from the handheld device to the service provider over the service provider communication channel.

In alternative embodiments, the methods include transferring service provider data from the service provider to the handheld communication device over the service provider communication channel and transferring the service provider data (or a derivative thereof) from the handheld communication device to the control system over the first wireless communication channel.

In other embodiments, the methods include both transferring control system data from the control system to the service provider through the handheld device and transferring service provider data to the control system through the handheld device (e.g., the service provider data may be generated in response to the control system data and/or the control system data may be produced in response to the service provider data).

In one exemplary embodiment, the handheld communication device is a mobile (e.g., cellular) telephone. In such an embodiment, the second wireless channel may be radio communication channel with a base station (e.g., a cell site) in a mobile data network. Alternatively, the second wireless channel may comprise a channel in a wireless wide area network (WWAN), a satellite communication channel, a direct radio link with a fixed base station, etc. Thus, the wireless communication provider node may comprise a remote WWAN node, an orbital communication satellite, etc. The service provider channel may also include additional communication links. For example, the wireless communication provider node may be linked to an internet-connected network to complete the channel to an internet-connected service provider.

In other exemplary embodiments, the control system may comprise a vehicle control system, a commercial and/or residential building control system, an appliance control system (e.g., a control system in a clothes washer and/or dryer, refrigerator, dishwasher, etc.), etc. The control system is generally integrated within a larger system (e.g., a vehicle, building, appliance, etc.), and may control, receive sensor and/or other data from, and/or otherwise interact with other sub-systems in the larger system (e.g., a powertrain subsystem in a vehicle, a security system or an energy management system in a building, a temperature control system in a refrigerator, a motor controller in an appliance, etc.).

In an exemplary vehicle control system, the control system data (e.g., the data transferred to the handheld device) may include vehicle status information such as door status, window status, trunk status, internal temperature, external temperature, tire pressure, vehicle registration number, date of last oil change, date of last maintenance, vehicle mileage, light status, global positioning system or other location information, vehicle damage information, vehicle maintenance status, etc.

In some embodiments, the first and/or second wireless communication channels may be encrypted and/or cryptographically signed. Furthermore, individual messages, packets, data blocks, or other groups of data transmitted on the wireless communication channel(s) may be encrypted and/or cryptographically signed according to processes and protocols well known to those skilled in the art. The encryption may be accomplished using one or more shared cryptographic keys and/or public/private key pairs.

In another exemplary embodiment, the method includes providing a user interface for interacting with the control system. The user interface may include functionality such as selecting a control system from one or more available control systems, entering a user password (e.g., for authenticating the user to the control system), formatting and/or displaying the control system data received over the first wireless connection (e.g., displaying vehicle status information), selecting a portion of the control system data for sending to the service provider, etc. In another embodiment, the user interface includes functionality for selecting user commands and the method includes sending user command data to the control system in response to the user interface.

In yet another embodiment, the method includes transferring the user password or a derivative thereof from the handheld communication device to the control system over the first wireless communication channel and checking the user password or a derivative thereof in the control system before transferring the control system data.

In still another embodiment, the user command data and/or the service provider data includes computer-readable instructions (e.g., command codes, software, firmware, etc.) adapted to operate in the control system and/or one or more subsystems coupled to the control system. For example, the service provider data may include a firmware update for the control system and/or one or more of the sub-systems that may be coupled to the control system. In embodiments including a vehicle control system the service provider data and/or the user command data may include, for example, instructions for locking and/or unlocking a vehicle door, activating and/or deactivating a light (e.g., a headlight, interior lamp, etc.), activating and/or deactivating a seat heater, etc.

Another exemplary embodiment relates to software (e.g., computer-readable media including computer-executable instructions) including instructions adapted to operate in a handheld communication device as disclosed herein. Yet another exemplary embodiment relates to software including instructions adapted to operate in a control system as disclosed herein.

Still more embodiments relate to handheld communication devices configured to interact with a control system and a service provider as disclosed herein. The devices generally include a controller and at least one radio component adapted to transmit and receive data using one or more wireless communication protocols. The controller is generally configured to establish the first wireless communication channel with the control system using one of the wireless communication protocols, receive control system data from the control system over the first wireless communication channel, establish a service provider communication channel with the service provider, including a second wireless communication channel between the handheld communication device and a wireless communication provider node using another one of the one wireless communication protocols, and transfer the control system data or a derivative thereof to the service provider over the service provider communication channel.

Still other embodiments relate to control systems configured to interact with a handheld communication device and a service provider as disclosed herein. The control systems generally include a radio component adapted to transmit and receive data using a wireless communication protocol, one or more data sources, and a controller component. The controller component is configured to establish a wireless communication channel with a handheld communication device using the wireless communication protocol, receive a request from the handheld communication device over the wireless communication channel, retrieve control system data from at least one of the data sources in response to the request, and transmit the control system data to the handheld communication device over the wireless communication channel for retransmission to the service provider.

In exemplary control systems, the one or more data sources include a memory and/or a mass data storage. In other exemplary control systems, the one or more data sources comprise status sensors. In exemplary vehicle control systems, the control system data (e.g., data retrieved from data sources such as memory, mass data storage, sensors, etc.) may include vehicle status information such as door status, window status, trunk status, internal temperature, external temperature, tire pressure, vehicle registration number, date of last oil change, date of last maintenance, vehicle mileage, light status, global position, vehicle damage information, and vehicle maintenance status, etc.

In other exemplary control systems, the controller component is further configured to receive authentication data over the wireless communication channel and to authenticate a user identity and/or a device identity in response to the authentication data. The user identity may include data corresponding to a user of the handheld communication device (e.g., a user name). The device identity may include data corresponding to the device itself (e.g., a device certificate). In further embodiments, the controller component of the control system is configured to authorize the request based on the user identity and/or the device identity.

In another embodiment of the control system, the controller component is configured to receive command data from the handheld communication device over the wireless communication channel and to provide command signal to the one or more control outputs in response to the command data. The command data may originate with the handheld communication device, the remote service provider, or both.

In a further embodiment, the controller is configured to authenticate a service provider, handheld device, or user identity in response to the command data (e.g., the controller may compare the identity to an access control list). The command data may include software adapted to operate the controller component and/or one or more subsystems coupled to the controller component. In some embodiments, the software may comprise updated firmware for the controller component and/or other subsystems. Alternatively, the command data may include simpler directives. For example, in a vehicle control system the command data may include instructions for locking or unlocking a door, activating or deactivating a light, activating or deactivating a seat heater, etc.

In general, this specification discloses methods, devices, software, and systems for providing an interactive bridge to connect the control systems of vehicles, building systems, and other durable goods to service providers (e.g., roadside assistance centers, manufacturer technical assistance centers, maintenance and/or repair services, etc.) using a handheld communication device. For example, one or more embodiments advantageously provide for interaction with the control systems of vehicles and other durable devices and systems over a wireless communication channel using relatively inexpensive handheld communication devices. One or more embodiments also provide for a wireless interactive bridge between these control systems and service providers (e.g., roadside assistance centers, manufacturer technical assistance centers, maintenance and/or repair services, etc.) using the handheld communication device.

These and other advantages of the present invention will become readily apparent from the detailed description of embodiments below.

### BRIEF DESCRIPTION OF THE DRAWINGS

FIG. 1A shows a flowchart of an exemplary method for interacting with a control system.

FIG. 1B shows a flowchart of another exemplary method for interacting with a control system.

FIG. 2A is a diagram showing an exemplary embodiment of a handheld communication device.

FIG. 2B is a diagram showing an exemplary embodiment of a mobile telephone.

FIG. 2C is a diagram showing an exemplary embodiment of a media player.

FIG. 2D is a diagram showing an exemplary embodiment of a wirelessly controllable system or device.

FIG. 2E is a diagram showing an exemplary embodiment of wirelessly controllable vehicle.

FIG. 3 is a diagram showing an exemplary system for wireless interaction with a vehicle.

FIG. 4 shows a flowchart of an exemplary method in a vehicle control system.

FIG. 5 is a diagram showing an exemplary dedicated system for wireless interaction with vehicles in a vehicle service environment.

FIG. 6 is a diagram showing an exemplary system for wireless interaction with a building control system.

### DETAILED DESCRIPTION

Reference will now be made in detail to embodiments of the invention, examples of which are illustrated in the accompanying drawings. While the invention will be described in conjunction with the embodiments, it will be understood that they are not intended to limit the invention to these embodiments. On the contrary, the invention is intended to cover alternatives, modifications and equivalents that may be included within the scope of the invention as defined by the appended claims. Furthermore, in the following detailed description of the embodiments of the present invention, numerous specific details are set forth in order to provide a thorough understanding of the embodiments of the present invention. However, the embodiments of the present invention may be practiced without these specific details. In other instances, well-known methods, procedures, components, and circuits have not been described in detail so as not to unnecessarily obscure aspects of the embodiments of the present invention.

Some portions of the detailed descriptions which follow are presented in terms of processes, procedures, logic blocks, functional blocks, processing, and other symbolic representations of operations on data bits, data streams or waveforms within a computer, processor, controller and/or memory. These descriptions and representations are generally used by those skilled in the data processing arts to effectively convey the substance of their work to others skilled in the art. A process, procedure, logic block, function, operation, etc., is herein, and is generally, considered to be a self-consistent sequence of steps or instructions leading to a desired and/or expected result. The steps generally include physical manipulations of physical quantities. Usually, though not necessarily, these quantities take the form of electrical, magnetic, optical, or quantum signals capable of being stored, transferred, combined, compared, and otherwise manipulated in a computer, data processing system, or logic circuit. It has proven convenient at times, principally for reasons of common usage, to refer to these signals as bits, waves, waveforms, streams, values, elements, symbols, characters, terms, numbers, or the like.

It should be borne in mind, however, that all of these and similar terms are associated with the appropriate physical quantities and are merely convenient labels applied to these quantities. Unless specifically stated otherwise and/or as is apparent from the following discussions, it is appreciated that throughout the present application, discussions utilizing terms such as “processing,” “operating,” “computing,” “calculating,” “determining,” “manipulating,” “transforming,” “displaying” or the like, refer to the action and processes of a computer, data processing system, logic circuit or similar processing device (e.g., an electrical, optical, or quantum computing or processing device), that manipulates and transforms data represented as physical (e.g., electronic) quantities. The terms refer to actions, operations and/or processes of the processing devices that manipulate or transform physical quantities within the component(s) of a system or architecture (e.g., registers, memories, other such information storage, transmission or display devices, etc.) into other data similarly represented as physical quantities within other components of the same or a different system or architecture.

Furthermore, for the sake of convenience and simplicity, the terms “data,” “data stream,” “waveform” and “information” may be used interchangeably, as may the terms “connected to,” “coupled with,” “coupled to,” and “in communication with” (which terms also refer to direct and/or indirect relationships between the connected, coupled and/or communication elements unless the context of the term's use unambiguously indicates otherwise), but these terms are generally given their art-recognized meanings. Also, for convenience and simplicity, the terms “channel,” “connection,” and “link” may be used interchangeably, and generally refer to direct, indirect, physical, virtual, and/or logical means for conveying information from a sender to a receiver (uni-directionally and/or bi-directionally).

The invention, in its various aspects, will be explained in greater detail below with regard to exemplary embodiments.

Exemplary Methods

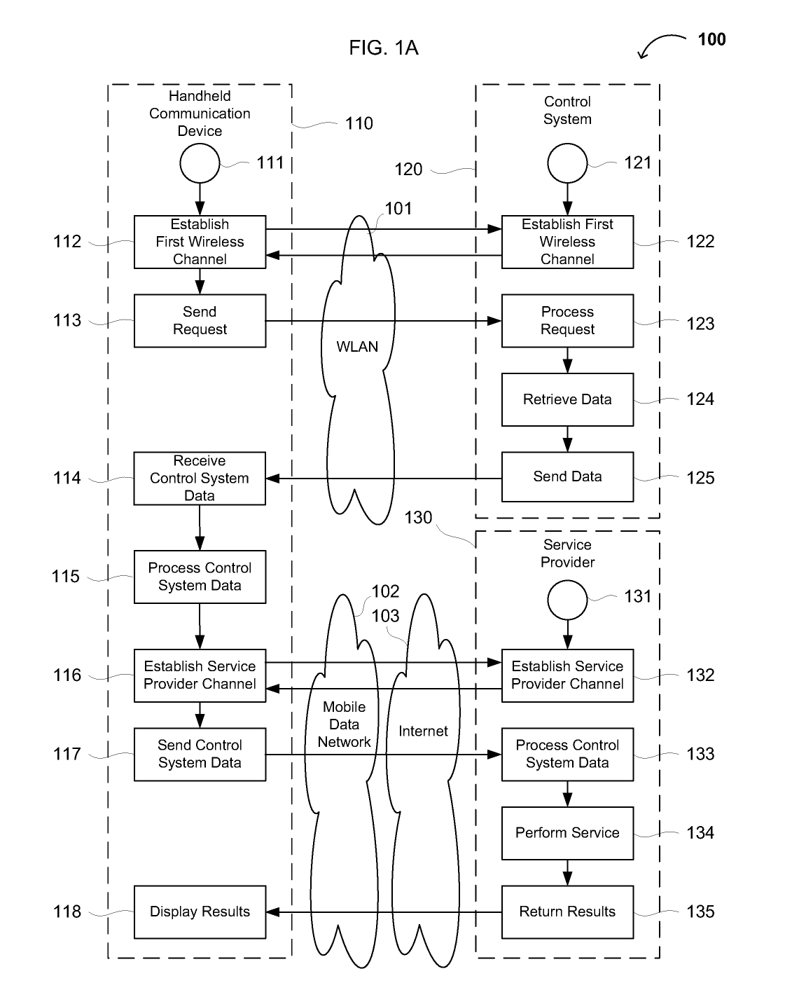

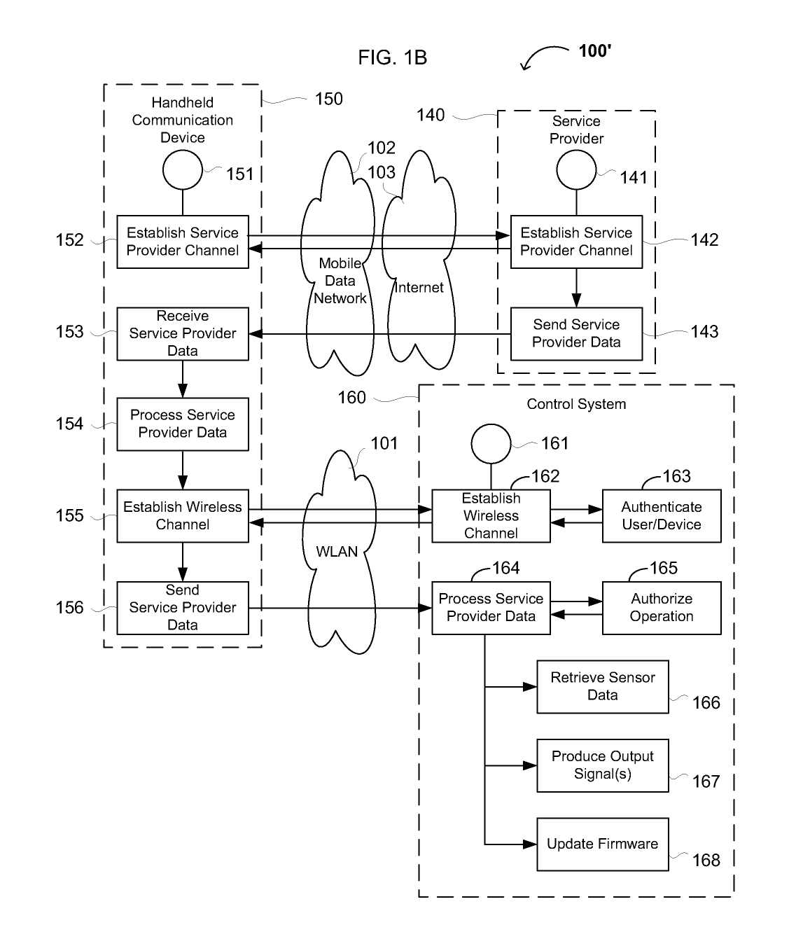

FIG. 1A shows a flowchart 100 of an exemplary method for interacting with a control system. The method generally includes operations 110 performed by or on a handheld communication device (“handset”), operations 120 performed by or on the control system, and operations 130 performed by or on a service provider. The handset operations 110 begin at starting point 111 and proceed to step 112 to establish a first wireless communication channel between the handset and the control system. Step 122 may include providing a user interface on the handset including functionality such as selecting a control system from one or more available control systems, entering a user password (e.g., for authenticating the user to the control system), etc.

The control system operations 120 begin at starting point 121 and proceed to step 122 to establish the first wireless channel. Either the handset or the control system may initiate the connection, and one or both of the establishing steps 112 and 122 may include discovery, handshaking, authentication, etc. For example, step 112 may include transferring a user password or a derivative thereof (e.g., a signed, encrypted, hashed, or otherwise transformed password) from the handset to the control system. Step 122 may include checking the user password in the control system before establishing the connection.

In this exemplary embodiment, the first wireless connection operates through a wireless local area network (WLAN) 101 (e.g., a Wi-Fi network conforming to one or more of the IEEE 801.11a/b/g/n standards). Alternatively, the first wireless connection may include a point-to-point connection (e.g., a Wi-Fi ad hoc connection, a direct radio frequency link, an infrared data link, etc.) between the handset and the control system.

At step 113 (e.g., after the first wireless channel is established) the handset requests data to the control system (e.g., by sending a request message over the first wireless channel). Step 113 may include, for example, providing a user interface on the handset for selecting a request, command, or other operation to perform on the control system. A request message may include, for example, a request for control system data status, maintenance, or other information relevant to the control system's function. At step 123, the control system receives and processes the request. At step 124 the control system retrieves the requested data (e.g., by retrieving the status data from a memory and/or by receiving a sensor or other status signal directly) and at step 125 the control system sends the control system data to the handset (e.g., over the first wireless channel).

One or more of the communication channels and/or channel segments may be encrypted and/or cryptographically signed. Furthermore, individual messages, packets, data blocks, or other groups of data transmitted on the communication channels of the present method may be encrypted and/or cryptographically signed according to processes and protocols well known to those skilled in the art. The encryption may be accomplished using one or more shared cryptographic keys and/or public/private key pairs.

At step 114 the handset receives the control system data. At step 115 the handset processes the control system data. For example, the handset may be configured to select, reformat, or otherwise transform all or a portion of the control system data. The handset may also add additional data, such as user authentication data, payment data, service request data, etc. Step 115 may also include providing a user interface on the handset. The user interface may include, for example, operations for formatting and/or displaying the control system data, selecting a portion of the control system data for sending to the service provider, etc.

At step 116 the handset establishes a service provider communication channel with a service provider. The handset may perform step 116 in response to step 115 (e.g., in response to predefined status or conditions indicated in the control system data, in response to user input, etc.), or may independently establish the service provider channel (e.g., in response to a predefined scheduled, in response to a request from the service provider, etc.).

The service provider operations 130 begin at starting point 131 and proceed to step 132 to establish the service provider channel. Either the handset or the service provider may initiate the connection, and one or both of the establishing steps 116 and 131 may include discovery, handshaking, authentication, etc. The service provider communication channel includes a second wireless communication channel (e.g., between the handheld communication device and a wireless communication provider node over a mobile data network 102), and may also include further communication segments or “hops” (e.g., through the internet 103). At step 117 the handset sends the control system data (or a derivative thereof, such as a selected, reformatted, or otherwise transformed portion or whole part of the control system data as processed at step 115) from the handheld device to the service provider over the service provider communication channel.

At step 133 the service provider receives and processes the control system data. Steps 117 and 133 may include many separate transmissions, each of which may be associated with the others at the physical link layer, the network layer, the application layer (e.g., by “cookies” or other sessions identification data) and/or any other layer or layers of communication between the handset and the service provider. Conversely, individual transmissions on the service provider “channel” may be considered and/or treated as independent transmissions at one or more of these network layers and/or through one or more network “hops” between the handset and the service provider. For example, the service provider channel may comprise a hypertext transfer protocol (HTTP) session.

At step 134 the service provider performs a service based on the control system data and/or on handset-provided data (e.g., data or requests entered by a user of the handset through a user interface). Services that may be performed at step 134 include, but are not limited to, those described herein with respect to exemplary embodiments. At step 135, the service provider returns results of the service and at step 118 the handset displays the results. Alternatively, the handset may further process the results (e.g., based on user input). For example, the handset may process the service provider results and/or retransmit them to the control system as shown in steps 153 through 168 of flowchart 100′ in FIG. 1B, as described below.

Referring now to FIG. 1B, an exemplary flowchart 100′ of a method for interacting with a control system in response to a service provider is shown. Handset operations 150 begin at starting point 151 and proceed to step 152 to establish a service provider communication channel with a service provider over mobile data network 102 and internet 103.

The service provider operations 140 begin at starting point 141 and proceed to step 142 to establish the service provider channel. Either the handset or the service provider may initiate the connection, and one or both of the establishing steps 152 and 142 may include discovery, handshaking, authentication, etc. At step 143 the service provider sends service provider data to the handset.

The service provider data may include commands and/or data. For example, the service provider data may include software (e.g., computer-executable instructions) adapted to operate in the control system and/or one or more subsystems coupled to the control system. The software may comprise updated firmware for the controller component and/or other subsystems. Alternatively, the service provider data may include simpler directives. For example, in a vehicle control system the command data may include directives to lock or unlock a door, activate or deactivate a light, activate or deactivate a seat heater, etc.

At step 153, the handset receives the service provider data over the service provider channel. At step 154 the handset processes the server provider data. Step 154 may include, for example, authenticating the data, providing a user interface for selecting, viewing, or otherwise manipulating the data, etc. At step 155 the handset establishes a wireless communication channel over WLAN 101.

Control system operations 160 begin at starting point 161 and proceed to step 162 to establish the wireless channel over WLAN 101. Steps 155 and 162 may include discovery, handshaking, authentication, etc. Thus, step 162 may proceed to step 163 to authenticate a service provider, handheld device, or user identity. At step 156, the handset sends the service provider data (or a selected and/or otherwise transformed whole or part of the service provider data) to the control system.

At step 164, the control system processes the service provider data. Processing the service provider data may include further authenticating the service provider, handheld device, or user identity (e.g., the service provider data may include data corresponding to one or more authorized service providers, handheld devices, and/or users). At optional step 165, the control system authorizes commands contained in the service provider data (e.g., by comparing service provider, device, or user identity information with an access control list [ACL]). In response to the service provider data, the control system may, for example, perform step 166 to retrieve and return sensor and/or status data, perform step 167 to produce an output signal (e.g., a control signal to another device or sub-system), perform step 168 to update the firmware of the control system or other associated sub-system, and/or perform any other action consistent with commands, instructions, or information contained in the service provider data.

An Exemplary Handheld Communication Device

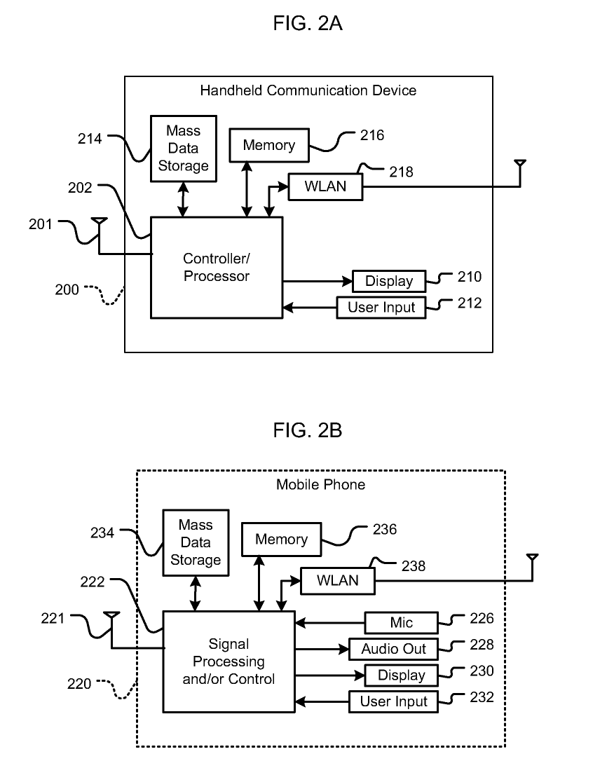

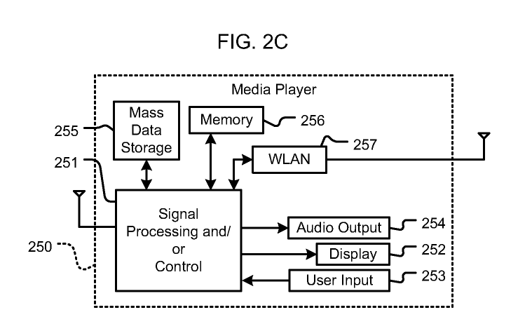

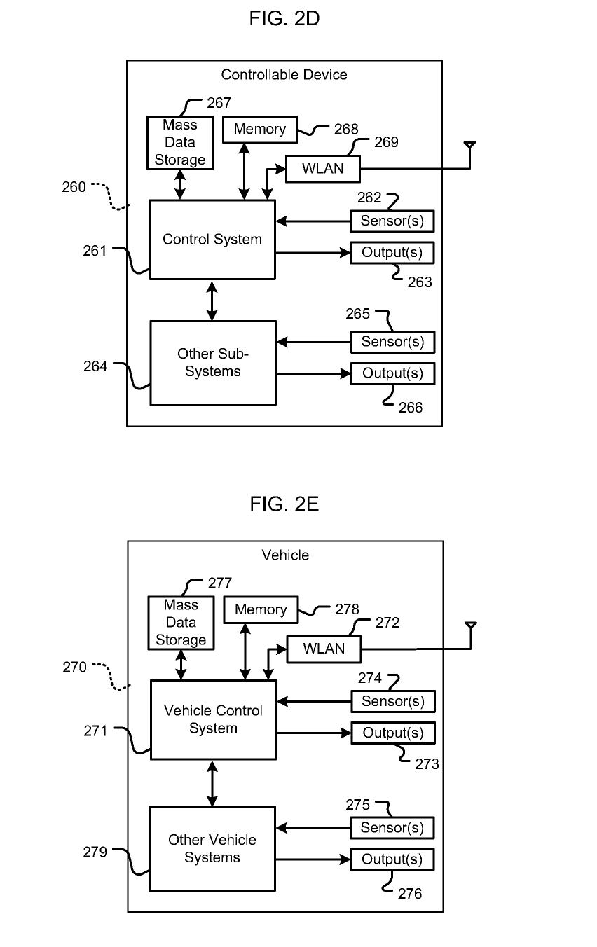

FIG. 2A shows an exemplary handheld communication device (“handset”) 200. The handset 200 generally performs handset operations 110 of FIG. 1A and/or handset operations 150 of FIG. 1B. Embodiments of the present invention may implement either or both signal processing and/or control circuits, which are generally identified in FIG. 2A at 202, a WLAN interface 218 and/or mass data storage of the handset 200. In some implementations, the handset includes a display 212 and/or an input device 210 such as a keypad, pointing device, voice actuation and/or other input device. The signal processing and/or control circuits 202 and/or other circuits (not shown) in the handset 200 may process data, perform coding and/or encryption, perform calculations, format data, etc.

The handset 200 may communicate with mass data storage 214 that stores data in a nonvolatile manner such as optical and/or magnetic storage devices (for example, hard disk drives [HDDs] and/or DVDs). The handset 200 may be connected to memory 216 such as RAM, ROM, nonvolatile memory such as flash memory and/or other suitable electronic data storage. Mass data storage 214 may store software or other computer-readable and -executable code adapted to perform part or all of the methods and/or operations described herein. Furthermore memory 216 may contain software and/or firmware for performing part or all of these methods and/or operations.

Handset 200 may support connections with a WLAN (or other wireless communication medium) via a WLAN network interface 218. Handset 200 may also support wide-area wireless communication through antenna 201. The wide-area wireless communication may include a mobile data network, a wireless wide area network (WWAN), satellite communication, a direct radio link with a fixed base station, etc.

An Exemplary Mobile Phone

FIG. 2B shows an exemplary cellular or mobile phone 220 configured to perform handset operations 110 of FIG. 1A and/or handset operations 150 of FIG. 1B. In addition to the features described with respect to handset 200 of FIG. 2A, mobile phone 220 may include, for example, a microphone 226 and an audio output 228 such as a speaker and/or audio output jack. The signal processing and/or control circuits 222 and/or other circuits (not shown) in the mobile phone 220 may process data, perform coding and/or encryption, perform calculations, format data and/or perform other cellular phone functions.

Other Exemplary Handheld Communication Devices

Other handheld communication devices may be configured to perform the handset operation described herein. For example, FIG. 2C shows an exemplary media player 250 including a display 252 an input device 253. The signal processing and/or control circuits 251 and/or other circuits (not shown) in the media player 250 may process data, perform coding and/or encryption, perform calculations, format data, etc. The media player 250 may include mass data storage 254, memory 256, and WLAN (or other wireless communication medium) network interface 257. Media player 250 may also support wide-area wireless communication through antenna 258.

An Exemplary Control System

FIG. 2D shows an exemplary embodiment of a wirelessly controllable system or device 260. Control system 261 may be configured to interact with a handheld communication device and a service provider as described herein. Controller 261 may also be coupled to one or more sensors 262 and/or one or more outputs 263, to a mass data storage 268, and/or a memory 268. Control system 261 may also be coupled a radio component (e.g., WLAN interface 269) adapted to transmit and receive data using a wireless communication protocol.

Control system 261 may be configured to establish a wireless communication channel with a handheld communication over wireless interface 269, receive a request from the handheld communication device over the wireless communication channel, retrieve control system data from one or more data sources (e.g., from memory, from sensors 262, from other sub-systems 264, etc.) in response to the request, and transmit the control system data to the handheld communication device over the wireless interface 269.

In exemplary embodiments, the wirelessly controllable device may be a vehicle control system, a commercial and/or residential building system, an appliance (e.g., a clothes washer and/or dryer, refrigerator, dishwasher, etc.), etc. The control system 261 is generally integrated within a larger system 260 (e.g., a vehicle, building, appliance, etc.), and may control, receive sensor and/or other data from, and/or otherwise interact with other sub-systems 264 in the larger system 260 (e.g., a security system or an energy management system in a building, a temperature control system in a refrigerator, a motor controller in an appliance, etc.).

An Exemplary Vehicle Control System

Referring now to FIG. 2E, an exemplary vehicle 270 includes a vehicle control system 271 according to the present embodiments. In vehicle 270, control system 271 may be coupled to WLAN or other wireless interface 277, mass data storage 279, memory 278, and one or more sensors 274 and outputs 273. Control system 271 may also be coupled to one or more other vehicle systems 274, which may be coupled to additional sensors 275 and outputs 276. Mass data storage 277 may include optical and/or magnetic storage devices (for example, hard disk drives [HDDs] and/or DVDs). Memory 278 may include RAM, ROM, nonvolatile memory such as flash memory and/or other suitable electronic data storage. Other systems 274 may include, for example, a powertrain control system. Sensors 274 and/or 275 may include sensors such as temperature sensors, pressure sensors, rotational sensors, airflow sensors and/or any other suitable sensors and/or that generates one or more output control signals such as engine operating parameters, transmission operating parameters, and/or other control signals. Vehicle control system 271 may be configured to run software adapted to perform one or more of the methods and operations described herein.

In some implementations, vehicle control system 271 may be part of an anti-lock braking system (ABS), a navigation system, a vehicle telematics system, a lane departure system, an adaptive cruise control system, a vehicle entertainment system such as a stereo, DVD, compact disc and the like. Still other implementations are contemplated.

An Exemplary System for Interacting with a Vehicle Control System

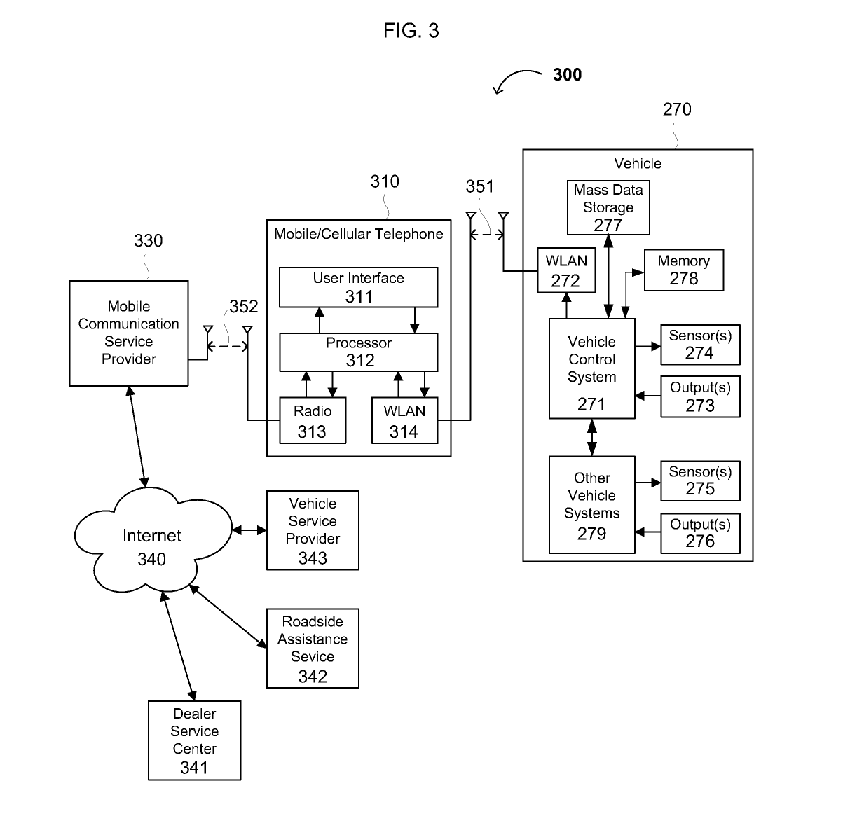

Referring now to FIG. 3, an exemplary system 300 includes mobile telephone handset (e.g., a cellular telephone) 310 and a vehicle 270. Mobile telephone 310 generally performs handset operations 110 of FIG. 1A and/or handset operations 150 of FIG. 1B. Vehicle 270 generally corresponds to an exemplary vehicle as described with respect to FIG. 2E, and includes vehicle control system 271 configured to perform operations such as control system operations 120 of FIG. 1A and/or control system operations 160 of FIG. 1B. Thus, mobile telephone 310 communicates with vehicle control system 271 over wireless communication channel 251 (e.g., over a WLAN).

Mobile communication service provider 330 provides mobile data services such as short message service [SMS] messaging and/or high speed wide area data networking such as General Packet Radio Service (GPRS), Enhanced Data rates for GSM Evolution (EDGE), Evolution-Data Optimized (EV-DO), etc. Mobile communication service provider may further provide data connectivity to internet 340. A variety of internet-connected service providers such as such as dealer service center 341, roadside assistance service 342, vehicle service provider 343, etc. may be available to the mobile telephone 310. Thus, the mobile telephone may establish communication channels with one or more service providers. These service provider channels may have segments including a radio communication channel with a base station in the mobile data network provided by mobile communication service provider 330, as well as segments including communication over internet 340.

Mobile telephone 310 may include a WLAN interface 314 (e.g., for communicating with vehicle 270 as described with respect to steps 112-114 of FIG. 1A and steps 155-156 of FIG. 1B) and a radio or other mobile data network interface 313 (e.g., for communicating with mobile communication service provider 330 and thereby to internet-connected service providers).

Mobile telephone 312 further includes one or more processors 312 (e.g., microprocessors, digital signal processors, application specific integrated circuits [ASICs], etc.) configured to interact with user interface 311, radio interface 313, and/or WLAN interface 314). The user interface may include, for example display screens (which may include a touch-screen interface), keypads, keyboards, voice recognition, etc. Processor 312 may be configured to run software (e.g., computer-executable instructions) adapted to perform one or more of the methods described herein.

Mobile telephone 310 may provide one or more user interfaces 311 for interacting with vehicle 270 and/or the service providers. For example, user interface 311 may include operations for selecting vehicle 270 from one or more available vehicles (and/or from one or more interoperable control systems) and entering a user id and/or password (e.g., for authenticating the user to the vehicle control system 270). User interface(s) 311 generally provides output to a user (e.g., through display 230, audio out 228, or other user-perceivable outputs of mobile phone 220, as shown in FIG. 2B) and receives input from the user (e.g., via user input 232 and/or microphone input 226 as shown in FIG. 2B).

The user interface may also include functionality for selecting user commands to be sent to vehicle 270, such as locking and/or unlocking a vehicle door, activating and/or deactivating a light (e.g., a headlight, interior light, etc.), activating and/or deactivating a seat heater, etc. The mobile telephone may send the commands to vehicle control system 271 over connection 351. Furthermore, the user interface may include functionality for formatting and displaying vehicle status information (e.g., data retrieved from vehicle control system 271 over connection 351) such as door status, window status, trunk status, internal temperature, external temperature, tire pressure, vehicle registration number, date of last oil change, date of last maintenance, vehicle mileage, light status, global position, vehicle damage information, and vehicle maintenance status, etc.

Mobile telephone 310 may also be configured to transmit part or all of the vehicle status information to a service provider. For example, mobile telephone 310 may retrieve maintenance or diagnostic information from vehicle 270 and send the information to a dealer service center 341. Dealer service center may then schedule a repair appointment, send the user of mobile telephone 310 self-help instructions, or otherwise respond to the vehicle information. For example, the dealer may send commands, firmware updates, or other data that allows the vehicle control system 271 to “self-correct” a problem. Alternatively, mobile telephone 310 may retrieve global positioning system (GPS) location data as well as diagnostic or other status information from vehicle 270, and send the data to a roadside assistance service 342. Roadside assistance service 342 may respond to the data by, for example, contacting appropriate emergency responders, dispatching a tow truck or other appropriate roadside helper (e.g., a fuel delivery service), etc. Other vehicle service providers 343 may also be contemplated.

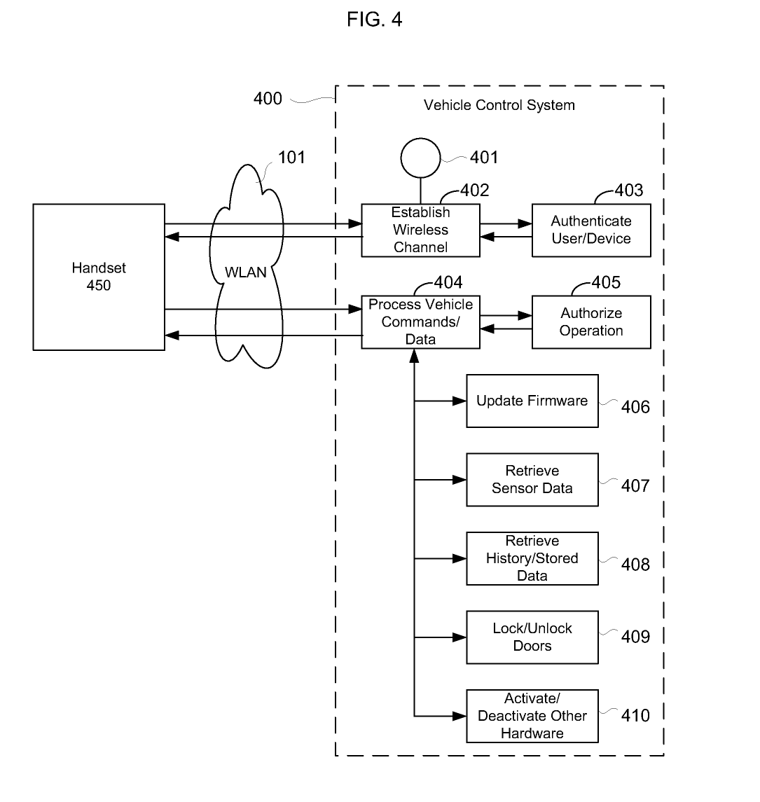

FIG. 4 shows an exemplary flowchart 400 of a method in a vehicle control system (e.g., vehicle control system 271). Flowchart 400 begins at starting point 401 and proceeds to step 401 to establish the wireless channel over WLAN 101 with a handset 450. Step 402 may proceed to step 403 to authenticate a service provider, handheld device, or user identity based on data exchanged while establishing the wireless channel. After the channel is established, the handset sends commands and/or data to the vehicle control system. The commands may include a request for data, software or firmware to run in the control system or in associated systems, simple directives, etc. The commands may originate with a service provider, with handset (e.g., from user input at the handset), or both.

At step 404, the control system processes the service provider data. Processing the service provider data may include further authenticating the service provider, handheld device, or user identity (e.g., the service provider data may include data corresponding to one or more authorized service providers, handheld devices, and/or users). At optional step 405, the vehicle control system authorizes the command data (e.g., by comparing service provider, device, or user identity information with an [ACL]). In response to the service provider data, the control system may, for example, perform step 406 to update the firmware of the vehicle control system and/or other vehicle systems, perform step 407 the vehicle control system may retrieve sensor data (e.g., to return to handset 450), perform step 408 to retrieve historical and/or stored data (e.g., data stored in memory 278 and/or mass data storage 277 of vehicle 270), perform step 409 to lock or unlock doors, perform step 410 to activate, deactivate, or otherwise operate other vehicle hardware (e.g., lamps, ignition, seat heaters, etc.), and/or perform any other action consistent with commands, instructions, or information contained in the command data.

An Exemplary Dedicated System

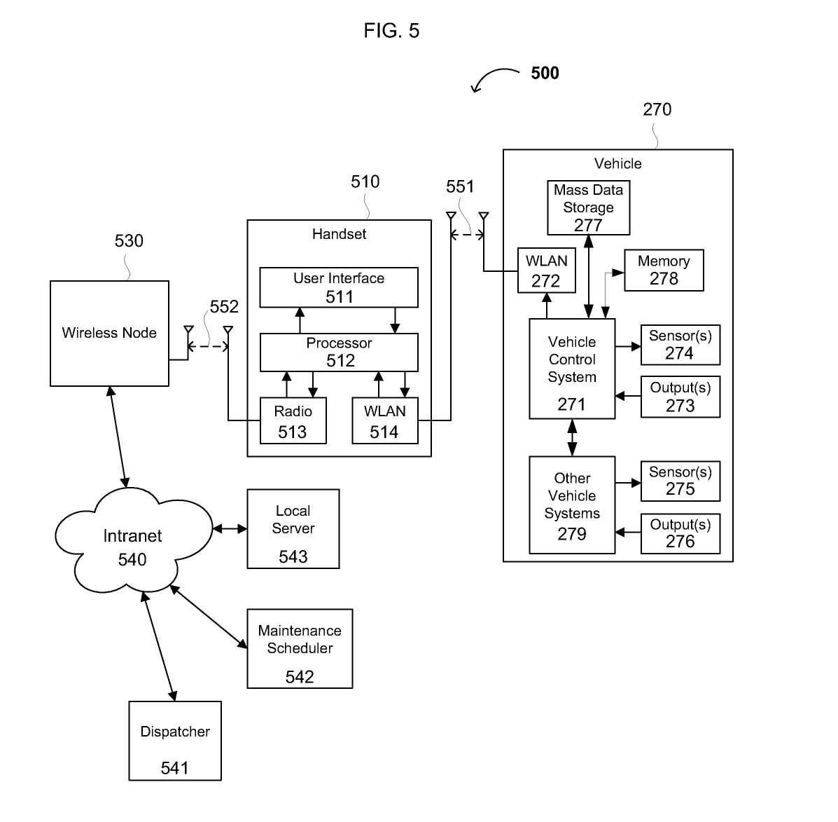

Referring now to FIG. 5, exemplary embodiments of the present invention are shown with respect to a dedicated system 500. In system 500, the handset 510 may be a special purpose device or a general purpose device with specialized software or other specialized configuration. For example, in a fleet, dealer, or independent garage or vehicle service center, handset 510 may be used to “check-in” each vehicle 270 as it arrives. The handset may establish a wireless connection with vehicles as they arrive, retrieve vehicle status information (e.g., mileage, maintenance or diagnostic information, etc.), and send the vehicle status information to a local or remote service provider (e.g., dispatcher 541, maintenance scheduler 542, local server 543, or other service provider) over wireless connection 552 to wireless node 530 and internet and/or intranet 540.

Wireless node 530 may be another node in a WLAN. Alternatively, wireless connection 552 may comprise a channel in a wireless wide area network (WWAN), a satellite communication channel (e.g., for geographically remote service centers), a direct radio link with a fixed base station, etc. Thus, the wireless node 530 may comprise a remote WWAN node, an orbital communication satellite, etc.

The service provider in this case may be a local server, a remote server, or a distributed system of servers. For example, dispatcher 541 may provide a response to the handset to tell the user (e.g., a garage employee) what to do next with the vehicle (e.g., wash it, place it in a particular parking location, send it for service, etc.) based on the vehicle status information. In another exemplary embodiment, maintenance scheduler 542 may schedule a maintenance service based on vehicle diagnostic data, maintenance history, mileage, etc. In yet another exemplary embodiment, the handset may transmit vehicle data to a local server 543 which may perform, for example, dispatching, scheduling, and/or other applications-specific processing of the vehicle data.

An Exemplary System for Interacting with a Building Control System

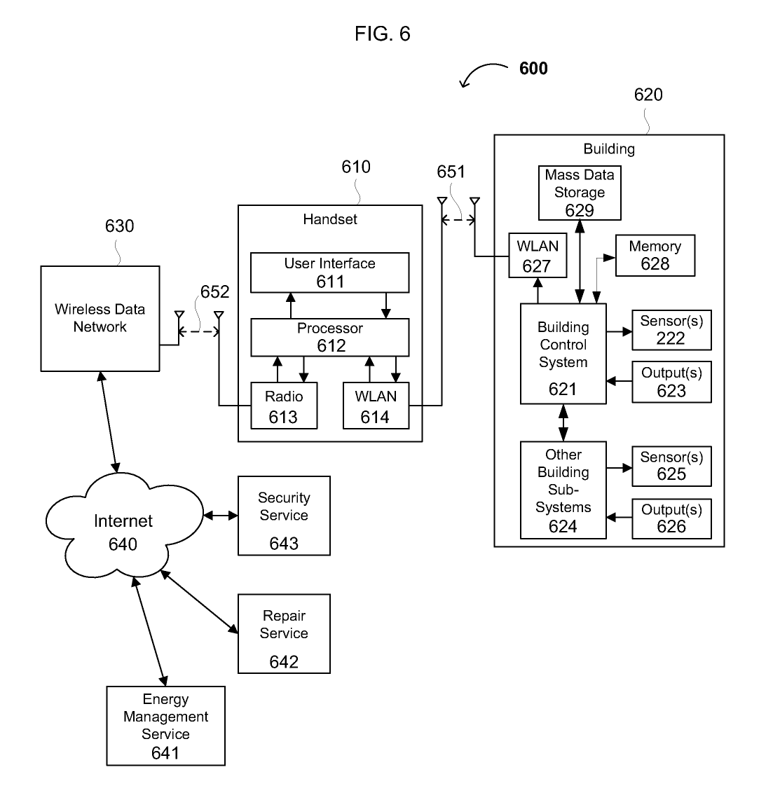

FIG. 6 shows exemplary embodiments of the present invention with respect to a system 600 for interacting with a building control system 621 and/or other sub-systems 624 in a building 620. Building 620 may be a commercial, residential, or other building with one or more automated or controllable systems, such as security systems, “smart” energy meters, access control systems, lighting systems, entertainment and/or multimedia systems, etc. Handset 610 may comprise a mobile telephone or other handheld communication device capable of wireless communication with both the building control system 621 and a wide area wireless data network 630. Handset 610 may be used by a resident, occupant, or other user of the building systems. In another exemplary embodiment, handset 610 may be used by a service technician to aid in diagnostics and/or maintenance of one or more of the sub-systems of building 620.

Handset 610 may provide a user interface 611 for interacting with the building control system 621 and one or more remote service providers. For example, user interface 611 may provide functionality for obtaining status from building control system 621 over wireless link 651. The building status information may include, for example, whether doors in the building 620 are locked and/or open, motion detector status, a video, still picture, and/or audio feed from a security camera and/or microphone, interior and/or exterior temperature, humidity and other climate data, etc. Building status information may also include current power usage, historical power usage, a power usage profile, etc., from a smart energy meter.

In another embodiment, user interface 611 may provide functionality for sending commands to the building control system 621 or other building sub-systems 624. Such commands may include, for example, locking or unlocking doors, activating or deactivating interior and/or exterior lights, opening doors (e.g., garage doors, disabled-accessible doors, etc.), arming or disarming a security system, controlling an entertainment system, setting a thermostat, etc.

The handset 610 may also be configured to send building data to a remote service provider. For example, the handset may send energy usage information to an energy management service 641. The service may process the data to provide, for example, competitive energy pricing, energy conservation suggestions, etc. In another embodiment, the handset may be configured to send building system data to a repair service 642. Repair service 642 may be a local repair and/or maintenance company, a centralized repair and/or maintenance service, a manufacturer service center, etc. The building system may include diagnostic data, maintenance history, etc. The repair service 642 may respond to the building system data by, for example, scheduling a maintenance or repair service call, sending instructions to the handset user, and/or sending updated firmware, software, and/or other “self-repair” instruction data to the handset for retransmission to the building control system 621 or other building system 624.

Exemplary Software

Another exemplary embodiment relates to algorithms, computer program(s) and/or software, (e.g., computer-readable media including computer-executable instructions) implementable and/or executable in handheld communication device, control system (e.g., a vehicle control system, building control system, or other wirelessly controllable system), or other device, apparatus, or system, having one or more microcontrollers, microprocessors, digital signal processors (DSPs), and/or application-specific integrated circuits, configured to perform one or more steps of the method and/or one or more operations of the hardware in accordance with the embodiments disclosed herein. Thus, a further aspect of the invention relates to algorithms and/or software that implement the above method(s). For example, embodiments of the invention may further relate to a computer program, computer-readable medium or waveform containing a set of instructions which, when executed by an appropriate processing device (e.g., a signal processing device, such as a microcontroller, microprocessor or DSP device), is configured to perform the above-described methods and/or algorithms.

For example, the computer program may be on any kind of readable medium, and the computer-readable medium may comprise any medium that can be read by a processing device configured to read the medium and execute code stored thereon or therein, such as a floppy disk, CD-ROM, magnetic tape or hard disk drive. Such code may comprise object code, bytecode (e.g., code for execution on a virtual machine, such as a Java virtual machine), source code and/or binary code.

The waveform is generally configured for transmission through an appropriate medium, such as copper wire, a conventional twisted pair wireline, a conventional network cable, a conventional optical data transmission cable, or even air or a vacuum (e.g., outer space) for wireless signal transmissions. The waveform and/or code for implementing the present method(s) are generally digital, and are generally configured for processing by a conventional digital data processor (e.g., a microprocessor, microcontroller, or logic circuit such as a programmable gate array, programmable logic circuit/device or application-specific [integrated] circuit).

### CONCLUSION/SUMMARY

Thus, embodiments of the present invention provide methods, systems, and devices for interaction with the control systems of vehicles and other durable devices and systems using relatively inexpensive handheld communication devices over a wireless communication channel. The embodiments also provide for an interactive bridge between these control systems and service providers (e.g., roadside assistance centers, manufacturer technical assistance centers, maintenance and/or repair services, etc.) using the handheld communication device.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for interacting with a control system, said method comprising:
establishing a first wireless communication channel between a handheld communication device and said control system;
transferring control system data from said control system to said handheld communication device over said first wireless communication channel;
establishing a second wireless communication channel between said handheld communication device and a service provider; and
transferring said control system data from said handheld communication device to said service provider over said second wireless communication channel.

2. The method of claim 1, wherein said control system comprises a vehicle control system.

3. The method of claim 2, wherein said control system data comprises vehicle status information selected from the group consisting of door status, window status, trunk status, internal temperature, external temperature, tire pressure, vehicle registration number, date of last oil change, date of last maintenance, vehicle mileage, light status, global position, vehicle damage information, and vehicle maintenance status.

4. The method of claim 1, wherein said second wireless communication channel comprises a Wide Area Network communication channel.

5. The method of claim 1, wherein said handheld communication device comprises a mobile phone.

6. The method of claim 5, wherein said second wireless communication channel comprises a service provider communication channel between said handheld communication device and a wireless communication provider node, and wherein said wireless communication provider node comprises a base station in a cellular data network.

7. The method of claim 1, wherein said first wireless communication channel comprises a Wireless Local Area Network (WLAN) communication channel.

8. The method of claim 1, wherein said first wireless communication channel comprises an encrypted connection and establishing said first wireless communication channel comprises selecting at least one cryptographic key.

9. The method of claim 1, further comprising providing a user interface in said handheld communication device for selecting said control system from one or more available control systems.

10. The method of claim 1, further comprising:
providing a user interface in said handheld communication device for entering a user password;
transferring said user password or a derivative thereof from said handheld communication device to said control system over said first wireless communication channel;
and checking said user password or a derivative thereof in said control system before transferring said control system data.

11. The method of claim 1, further comprising:
formatting said vehicle status data for display; and
providing a first user interface operation in said handheld communication device for viewing said formatted control system data.

12. The method of claim 11, further comprising providing a second user interface operation in said handheld device for selecting at least a portion of said control system data for said transferring to said vehicle service provider.

13. The method of claim 1, further comprising steps of:
transferring service provider data from said service provider to said handheld communication device over said second wireless communication channel; and
transferring said service provider data from said handheld communication device to said control system over said first wireless communication channel.

14. The method of claim 13, wherein said service provider data comprises computer-readable instructions adapted to operate in said control system and/or one or more subsystems coupled to said control system.

15. The method of claim 14, wherein said instructions comprise updated firmware.

16. The method of claim 14, wherein:
said control system comprises a vehicle control system;
said service provider data comprises instructions for performing operations selected from the group consisting of locking a door of a vehicle comprising said vehicle control system, unlocking said door, activating a light of said vehicle, deactivating said light, activating a seat heater of said vehicle, and deactivating said seat heater.

17. The method of claim 1, wherein said control system comprises one or more of a building control system, a residential control system.

18. A method for communicating with a control system, said method comprising:
establishing a first wireless communication channel between a handheld communication device and said control system;
establishing a second wireless communication channel between said handheld communication device and a service provider;
transferring service provider data from said service provider to said handheld communication device over said second wireless communication channel; and
transferring said service provider data from said handheld communication device to said control system over said first wireless communication channel.

19. A computer-readable medium comprising a computer- executable set of instructions stored therein, adapted to operate in a handheld communications device for interacting with a control system, said instructions adapted to:
establish a first wireless communication channel with said control system;
receive control system data from said control system over said first wireless communication channel;
establish a second wireless communication channel with a service provider; and
transfer said control system data or a derivative thereof to said service provider over said second wireless communication channel.

20. The computer-readable medium of claim 19, wherein said first wireless communication channel comprises an encrypted connection and said instructions adapted to establish said first wireless communication channel comprises instructions adapted to select at least one cryptographic key.

21. The computer-readable medium of claim 19, further comprising instructions adapted to provide a user interface for selecting said control systems from one or more available control systems.

22. The computer-readable medium of claim 19, further comprising instructions adapted to:
provide a user interface for entering a user password;
transfer said user password or a derivative thereof to said control system over said first wireless communication channel.

23. The computer-readable medium of claim 19, further comprising instructions adapted to:
format said control system data for display; and
provide a first user interface for viewing said formatted vehicle status data.

24. The computer-readable medium of claim 23, further comprising providing a second user interface operation in said handheld device for selecting at least a portion of said control system data for said transfer to said service provider.

25. The computer-readable medium of claim 19, further comprising instructions adapted to:
receive service provider data from said service provider over said service provider communication channel; and
transfer said service provider data or a derivative thereof to said control system over said first wireless communication channel.

26. The computer-readable medium of claim 19, wherein said control system comprises a vehicle control system.

27. A computer-readable medium comprising a computer- executable set of instructions stored therein, adapted to operate in a handheld communications device for interacting with a control system, said instructions adapted to:
establish a first wireless communication channel with said control system;
establish a service provider communication channel with a service provider, wherein said service provider communication channel includes a second wireless communication channel between said handheld communication device and a wireless communication provider node;
receive service provider data from said service provider over said service provider communication channel; and
transfer said service provider data or a derivative thereof to said control system over said first wireless communication channel.

28. A handheld communications device configured to interact with a control system, said device comprising:
at least one radio component adapted to transmit and receive data using one or more wireless communication protocols; and
a controller configured to:
establish a first wireless communication channel with said control system using a first one of said one or more wireless communication protocols,
receive control system data from said control system over said first wireless communication channel,
establish a second wireless communication channel between said handheld communication device and a service provider using a second one of said one or more wireless communication protocols, and
transfer said control system data or a derivative thereof to said service provider over said second wireless communication channel.

29. The device of claim 28, wherein said second one of said wireless communication protocols comprises a Wide Area Network communication protocol.

30. The device of claim 28, wherein said second wireless communication channel comprises a service provider communication channel between said handheld communication device and a wireless communication provider node, and wherein said wireless communication provider node comprises a base station in a cellular data network.

31. The device of claim 28, wherein said first one of said wireless communication protocols comprises a Wireless Local Area Network (WLAN) communication protocol.

32. The device of claim 28, wherein said first wireless communication channel comprises an encrypted connection and said controller is further configured to select at least one cryptographic key for establishing said first wireless communication channel.

33. The device of claim 28, further comprising a user interface for selecting said control systems from one or more available control systems.

34. The device of claim 28, further comprising a user interface for entering a user password, and wherein said controller is further configured to transfer said user password or a derivative thereof to said control system over said first wireless communication channel.

35. The device of claim 28, wherein said controller is further configured to format said control system data for display, and wherein said device further comprises a first user interface for viewing said formatted control system data.

36. The device of claim 35, further comprising a second user interface for selecting at least a portion of said control system data for said transfer to said service provider.

37. A mobile phone comprising the device of claim 28.

38. A control system comprising:
a radio component configured to transmit and receive data using a wireless communication protocol;
one or more data sources;
one or more control outputs; and
a controller component configured to
establish a first wireless communication channel with a handheld communication device using said wireless communication protocol,
receive a request from said handheld communication device over said first wireless communication channel,
retrieve control system data from at least one of said data sources in response to said request,
transmit said control system data to said handheld communication device over said first wireless communication channel for retransmission, via a second wireless communication channel, to a service provider, wherein said service provider is distinct from said communication device,
receive service provider data from said handheld communication device over said first wireless communication channel, said service provider data having originated with said service provider and having been received by said handheld communication device via said second wireless communication channel,
authenticate said service provider based on said service provider data, and
provide a command signal to said one or more control outputs responsive to said service provider data.

39. A vehicle control system comprising the control system of claim 38.

40. The vehicle control system of claim 39, wherein said one or more data sources comprise at least one of (i) a memory or (ii) a mass data storage.

41. The vehicle control system of claim 39, wherein said one or more data sources comprise one or more vehicle status sensors.

42. The vehicle control system of claim 39, wherein said control system data comprises vehicle status information selected from the group consisting of door status, window status, trunk status, internal temperature, external temperature, tire pressure, vehicle registration number, date of last oil change, date of last maintenance, vehicle mileage, light status, global position, vehicle damage information, and vehicle maintenance status.

43. The control system of claim 38, wherein:
said controller is further configured to
receive at least one of (i) user authentication data or (ii) device authentication data over said first wireless communication channel, and
authenticate at least one of (i) a user identity or (ii) a device identity in response to said at least one of (i) user authentication data or (ii) device authentication data;
said user identity comprises data corresponding to a user of said handheld communication device; and
said device identity comprises data corresponding to said handheld communication device.

44. The control system of claim 43, wherein said controller is further configured to authorize said request based on at least one of (i) said user identity or (ii) said device identity.

45. (canceled)

46. (canceled)

47. The control system of claim 38, wherein said command signal comprises computer-executable instructions adapted to operate at least one of (i) said controller component or (ii) one or more subsystems coupled to said controller component.

48. The control system of claim 47, wherein said instructions comprise updated firmware.

49. A vehicle control system comprising the control system of claim 38, wherein said command data comprises instructions for performing operations selected from the group consisting of locking a door of a vehicle comprising said vehicle control system, unlocking said door, activating a light of said vehicle, deactivating said light, activating a seat heater of said vehicle, and deactivating said seat heater.
